(19) United States
(12) Patent Application Publication
(10) Pub. No.: US 2007/0237233 A1
(43) Pub. Date: Oct. 11, 2007

(54) MOTION COMPENSATION IN DIGITAL VIDEO

(76) Inventor: Anthony Mark Jones, Beaverton, OR (US)

Correspondence Address: AMBRIC, INC.;C/O MARGER JOHNSON & MCCOLLOM PC, 210 SW MORRISON STREET, SUITE 400, PORTLAND, OR, 97204, US

(21) Appl. No.: 11/733,135

(22) Filed: Apr. 9, 2007

Related U.S. Application Data
(60) Provisional application No. 60/790,913, filed on Apr. 10, 2006.

(51) Int. Cl. H04N 11/02; H04B 1/66

(52) U.S. Cl. 375/240.16; 375/240.29

(57) ABSTRACT

Embodiments of the invention include a system directed to generating motion vectors in digital video by using multiple phases in sequence. In a first phase, a match signature in the frequency domain is evaluated to find one or more minimum motion vector candidates for a particular macroblock in video. In a second phase, the vector candidates are further refined using smaller-sized portions of the macroblock and fractional motion vectors to determine a small list of minimum vector choices for each macroblock that maintain vector integrity within the vector field of the frame and across nearby frames.

### CROSS REFERENCE TO RELATED APPLICATIONS

This application claims benefit of U.S. provisional application 60/790,913, filed on Apr. 10, 2006, entitled MOTION COMPENSATION IN DIGITAL VIDEO, which is incorporated by reference herein.

### TECHNICAL FIELD

This disclosure relates to digital video compression, and, more particularly, to a system of motion compensation for digital video compression.

### BACKGROUND

Digital video data contains voluminous information. Because transmitting uncompressed video data requires a tremendous amount of bandwidth, normally the video data is compressed before transmission and de-compressed after arriving at its destination. Several techniques abound for compressing digital video, some of which are described in ISO/IEC 14496-10, commonly known as the MPEG 4, part 10 Standard, which has much in common with the ITU's H.264 standard, described in a textbook entitled “Digital Video Compression,” by Peter Symes, ©2001, 2004, both of which are incorporated by reference herein.

One of the digital video compression techniques described in the above-incorporated references is motion estimation; the converse operation in the decoding process is motion compensation. Motion estimation is a way to better describe differences between consecutive frames of digital video. Motion vectors describe the distance and direction that (generally rectangular) picture elements in a video frame appear to move between successive or a group of frames of related video. Many video sequences have redundant information in the time domain, i.e., most picture elements show the same or a similar image, frame to frame, until the scene changes. Therefore, motion estimation, when attempting to find matches for each possible partition of the picture that has less difference information, generally determines that the motion vectors it finds are highly correlated. The compression system takes advantage of less picture differences and correlated vectors by using differential coding. Note that having correlated vectors means that generally a good to place to start searching for a match is by applying the previous vector, either for a neighboring element or the same element in a previous frame. One of the many problems in searching for a match is that many different candidate vectors can have a similar match value, and deciding which vector to finally choose is very difficult.

Traditional bottlenecks in motion estimation occur because of limitations in the ability to perform the computations, such as memory size or processing bandwidth. For example, searches may be limited to nearby locations only, and all possible vectors are not exhaustively tested. Bandwidth between a processor performing the motion calculations and external memory is exceedingly large during a search, and therefore processing is limited to the amount of resources available. These limitations can force a designer to make choices based on inexact matches, which in turn leads to less overall data compression. Generally, due to these resource limitations, search sizes are limited, not all possible partition sizes are considered, and some processes proceed only until there is no time left to search, all of which may lead to non-optimal results.

Embodiments of the invention address these and other limitations in the prior art.

### BRIEF DESCRIPTION OF THE DRAWINGS

FIG. 1 is a line drawing illustrating the range and level of precision used in a search area for a particular macroblock according to embodiments of the invention.

FIG. 2 is a block diagram illustrating a method of calculating minimum value according to embodiments of the invention.

FIG. 3 is a block diagram illustrating a method of generating DCT signature values according to embodiments of the invention.

FIG. 4 is a block diagram illustrating a comparison element according to embodiments of the invention.

FIG. 5 is a block diagram illustrating a method of using edge and region preferences used in embodiments of the invention.

FIG. 6 is a block diagram illustrating a method of producing a preferred predicted candidate.

FIG. 7 is a graph illustrating the results of a four-step search using results gained from embodiments of the invention.

FIG. 8 is a block diagram that illustrates a worst-case search scenario according to embodiments of the invention.

FIG. 9 is a block diagram of a MIMD processor on which embodiments of the invention can be practiced.

FIG. 10 is a block diagram illustrating a full encoder that uses embodiments of the invention.

### DETAILED DESCRIPTION

Some embodiments of the invention use a motion estimation system divided into two parts, or phases. In the first phase, an exhaustive search is performed over an entire HD (High Definition) frame for each 16×16 macroblock. In the second phase, the search is refined based on the global minima found in the first phase, and refinements may be performed for different partition sizes and for fractional vectors. Phase one has the advantage of minimizing external memory bandwidth and on-chip storage, and can also be further enhanced by using a other quality match criteria than SAD (Sum of Absolute Differences), a simplified matching criterion used in known systems. Phase two has the advantage of performing a logarithmic search technique directed by the minima from phase one, which reduces memory bandwidth and computation time. Further in phase two, to better balance memory bandwidth and computation time, a calculation using the quantization parameter (QP) may also be used during the search, rather than after the search in known systems. By using more complex calculations during the search, deciding which vector to use may be much nearer to the optimum choice. Further, the phase two refinements may be performed on more than one potential global candidate vector that was produced in the first phase to allow better choices after refinement. Further, the topology features from the phase one vector field may be used for: determining any global motions such as pan and zoom; determining how best to fracture the picture elements; and to smooth the vector choices so that the differential vector values do not change much as the picture is compressed.

The first phase has a goal of detecting the best match for a 16×16 macroblock, which is found by exhaustively calculating every match signature for each possible vector across an entire video frame. In the first phase, the vectors during the search may use integer-pel values only, without degrading the quality of the inventive motion vector system. Results from the first phase seed the phase two refinements. The best result of a match in phase one is the identification of a 16×16 macroblock that has a minimum difference within the context of matches to neighbors in the same frame and to matches across frames. Multiple vectors choices may be generated, so that a secondary high-quality logarithmic search completely covers all the areas where the optimum choice may be.

In phase one, the searches are performed using a match signature such as the Sum of All Differences or the Sum of All Square Differences. The SAD value is calculated using:

$${\sum }_{0}^{255} ABS ( {match}_{i} - {current}_{i} )$$

The SSD is calculated using:

$${\sum }_{0}^{255} {( [ {match}_{i} ] - [ {current}_{i} ] )}^{2}$$

The advantage of SAD is that no multiplications are required, although both SAD and SSD required that the every one of the 256 differences is summed for a 16×16 macroblock. The SSD signature is better than SAD because it is less affected by random noise in each pel value. Another alternative signature is to use a frequency domain transform so that high frequency terms (which the eye is insensitive to) can be discarded before comparison, and also allows a simple noise filter to be applied. Such a signature is a DCT16 signature, which is calculated from sixteen DCT4×4 transforms which are defined in the H.264 standard. The DCT4×4 does not require multiplications as defined. A match value for a 16×16 macroblock is determined by calculating:

$${\sum }_{0}^{255} ABS ( DCT 16 [ {match}_{i} ] - DCT 16 [ {current}_{i} ] )$$

A significant advantage is that many of the DCT terms in the summation can be ignored during the comparison. In preferred embodiments of the invention, the first phase uses memory bandwidth and local storage so efficiently that any or all of the signatures may be able to be computed in time, as compared to known systems where the balance of memory access and compute is such that only SAD can be used on a limited number of vector choices.

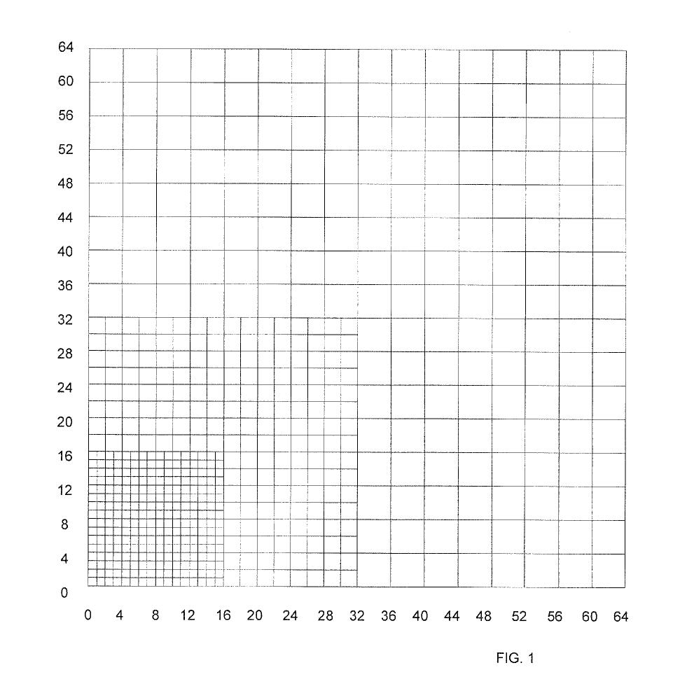

FIG. 1 illustrates a method for reducing the number of searches performed during phase one if resources are limited. It uses the known correlation by assuming that a match is going to be near neighboring matches. Thus the reduction is such that as the vector size increases, fewer points are searched. FIG. 1 shows a possible set of search points for one particular macroblock. In FIG. 1 only the intersection of gridlines are searched. It can be seen in FIG. 1 that near vectors are exhaustively searched and that far vectors are sampled. In FIG. 1, the origin of (0,0) is located at the lowest left-hand point and corresponds to the center of the best surrounding vector. Searching is performed at different quantization levels based on the distance from (0,0). Only the quadrant of positive values for x and y are illustrated in FIG. 1, although the quantization values are the same in each of the four compass directions. Thus, for example, the location (0,2) and (20,2) are searched, while the location (33,2) is not. A vector step may be limited to 16 in some embodiments, and any unsampled vectors (for example (33,2)) may be examined during the refinement in phase two. The quantization of near and far vectors during phase one is effective because the final choices in phase one only seed the second refinement search, which does not ignore any possibilities in the neighborhood.

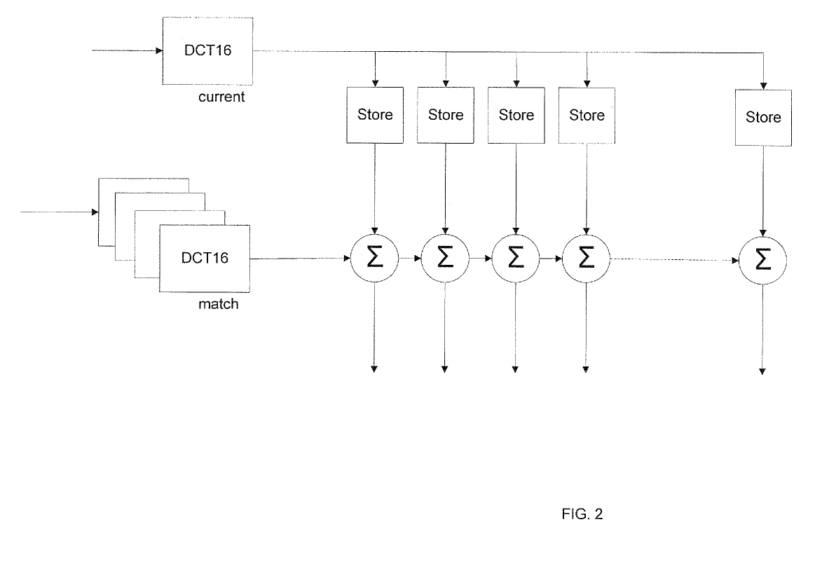

FIG. 2 illustrates a calculation performed in phase one. For instance, DCT signatures from the current frame are locally stored and a difference summation performed for match frames. Note that all of the match signatures are not routed through each comparison object, but in reality routed only to the correct comparison object.

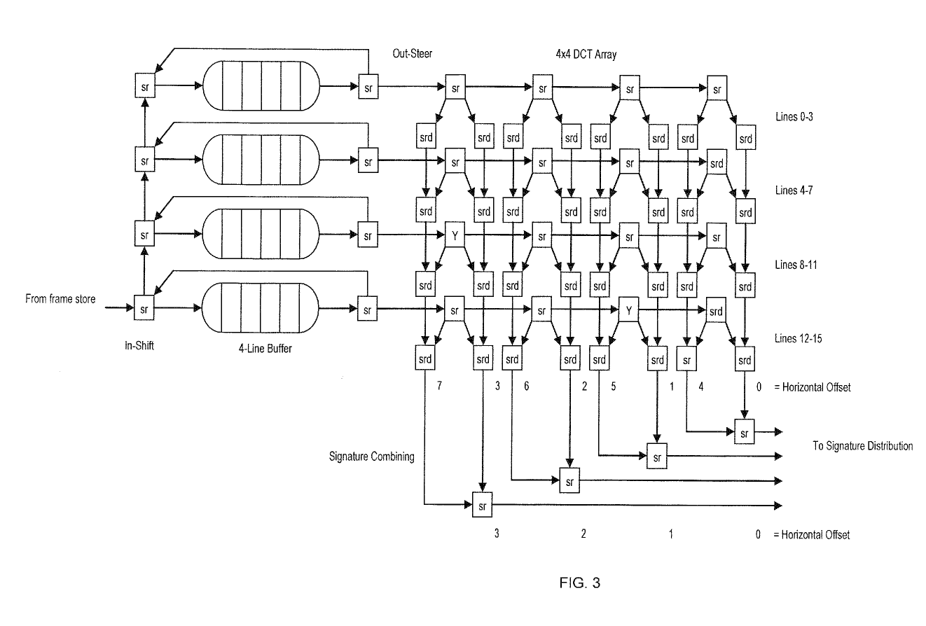

FIG. 3 illustrates an example system for generating DCT signature values. In FIG. 3, the label SR indicates a process, which may be performed by stand-alone hardware or by a small program executing on a processor. The label SRD indicates another process or processor, which may be different from the SR processor. The data from the video frame may be sent in packed bytes, and stored in 4×4 line 1K buffers.

To generate the DCT signature values, an entire row of macroblocks is buffered, and a 16×16 DCT value is calculated for every pixel location, and can use the stored 4×4 calculations. Therefore, each new vector location only needs four new DCT 4×4 values. To compute approximately 16.8 million DCT16 signatures, 67.1 million DCT 4×4s must be computed. Performing a DCT 4×4 can be coded to fewer than 100 instructions in a typical processor.

Thus, it is possible with the multi-processor cores of today, that phase one can perform the matches in the frequency domain on one or two chips, using a DCT match “signature” which can ignore noise and high-frequency terms and so lead to vector selections forming smooth vector fields that lock to natural picture motion, not noise and edges. It has been shown also that potentially phase one can also search exhaustively all integer-pel vector values across an entire HD frame using one or two chips, and (if needed) that quantizing the near and far searches can reduce the computation overhead without significant loss.

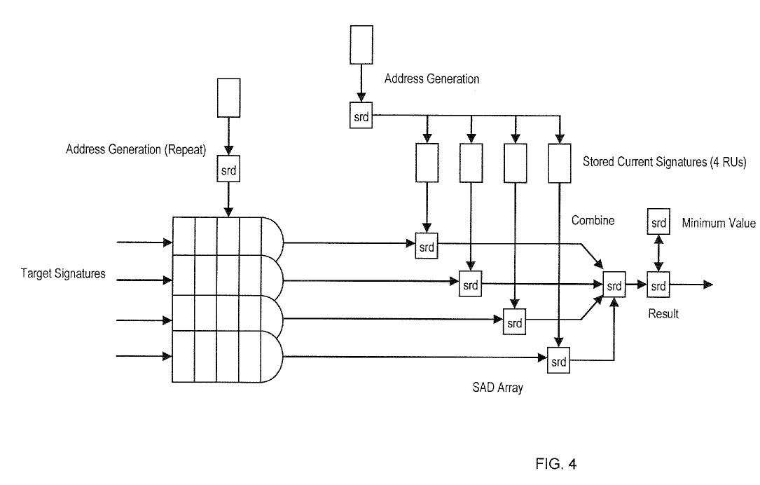

FIG. 4 illustrates an example of a comparison element, where the signature is stored and compared in stripes. One comparison element is 256 macro-blocks. Using a pipelined design compares a signature every 8 cycles.

Phase two of the motion estimation refines the vector(s) initially determined in phase one. Phase two includes some standard elements in motion estimation.

Phase two is “logarithmic” search using the commonly used four-step-search (FSS). The FSS is effective provided there are no false minima in the region of the search, and is a good prediction of motion in the surrounding macroblocks. The selection methods used to determine the starting seeds from phase one ensures that phase two provides near optimum results using the FSS.

More than one vector can start any FSS. The best vector candidates are either the seeds from phase one or ‘predicted vectors’ obtained from the phase two results of the neighbors' vectors using techniques described in the above-referenced H.264 standard. Also adaptive heuristics can be used to store “close-match” selections so that previous results for neighbors can be re-adjusted according to the result for the current macroblock. Being able to use the Quantization Parameter QP at this stage can help the heuristics, because after quantization many of the choices may become similar, and so a vector close to the predicted value that otherwise would have been rejected or skipped may become a better choice.

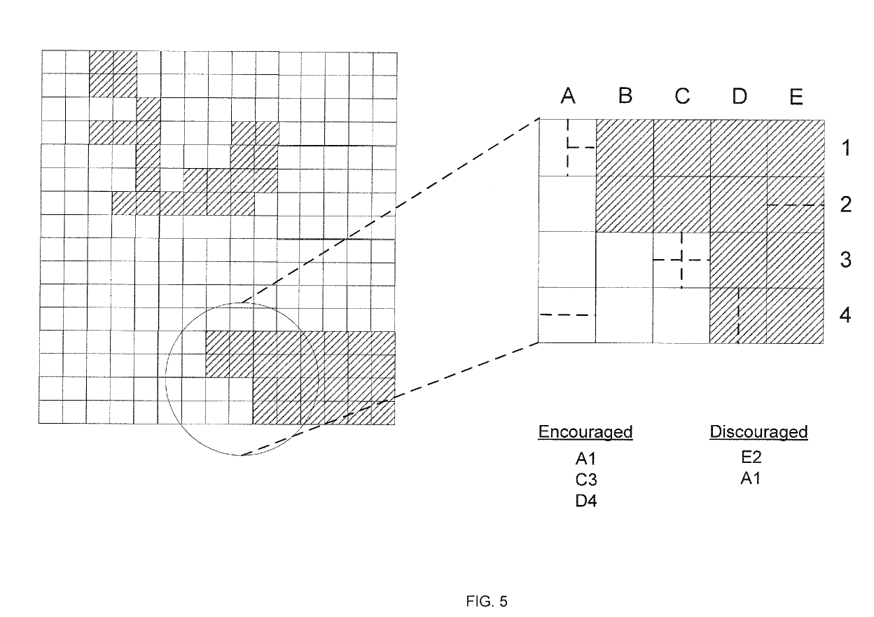

One of the aspects of refinement using the FSS is the ability to perform the FSS on all possible partition sizes, such as 4×4, 4×8, 16×8, 8×8 etc., as defined in the H.264 standard. One method to reduce the number of FSS searches is to use the topology from phase one to encourage and discourage certain fracture patterns and so limit the number of FSS searches performed for each 16×16 macroblock. FIG. 5 shows how region edges in the phase one vector field (regions are areas of similar vector candidate values) can be used to encourage and discourage different partition choices within each 16×16 macroblock.

In phase two, the phase one motion vector field is scanned (typically in display raster order), which detects the topology regions and generates the “predicted vectors” as additional start points for the phase two refinement. Next the FSS is performed for each of the partitions allowed by the topology regions. Next the integer-pel vector solution is refined to a quarter-pel resolution (which can have the quarter bits either both zero (integer-pel) or 10 (half-pel), and both results are output to the encoder. The above processes can be repeated with the additional candidate vectors, if any are present. Further, any matches that do give high difference values or distort the vector field wildly, for example a moving object such a ball disappearing behind a player or reappearing from behind a crowd, can be searched in other frames for a better match.

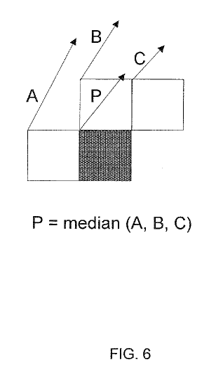

To produce the topology regions, each macroblock is tagged with an identifier according to the vector from phase one. “Similar” motion is set within parameterized bounds, for example a vector Euclidean length within +/− one pixel. Thus, macroblocks on a region edge will have a different identifier to a neighbor. The “predicted vector” candidate is calculated as described in the H.264 reference, as illustrated in FIG. 6, where the predicted vector is the median of nearby vectors for each partition size. The H.264 standard does also define how to compute the predicted vector when some of the vectors are missing, for example near the edge of a frame.

Next an FSS is performed and partitions selected. A significant feature of performing this calculation can include the order in which each partition size is searched (denoted as levels). Important considerations include where to start the search at each new level, and how to control the cost function for each level. These can be based on region biases and based on the cost of the previous level.

In performing the FSS, searching takes place +/− 16 pels, starting from a “parent” vector.

a) 16×16 refined search using macroblock candidate vector

b) two 16×8 searches using result of a) as a parent

c) two 8×16 searches using result of a) as a parent

d) four 8×8 searches using result of a) as a parent

e) eight 8×4 searches using results of d) as parent

f) eight 4×8 searches using results of d) as parent

g) sixteen 4×4 searches using results of d) as parent

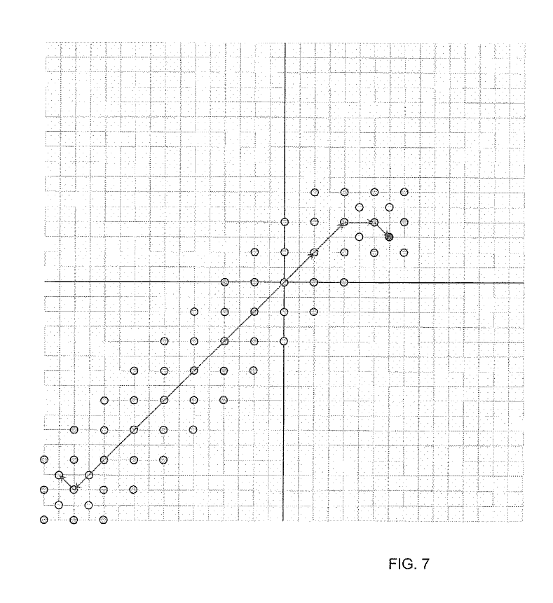

Each level can halt if the cost becomes too high, without affecting the completion of the next levels. If step d aborts, for instance, the parent vector does not change. Note that there are 7 (equivalent) 16×16 searches. FIG. 7 illustrates an FSS search, starting from the center point in the figure.

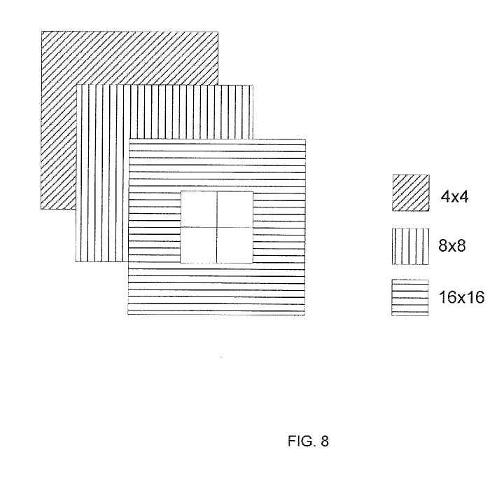

FIG. 8 illustrates the absolute worst-case searches, for all three levels, using a 48×48 buffer, which requires a worst-case total read of 9+2*5=19 16×16 blocks. Note that this scenario requires that the current level finish before the next section can be fetched.

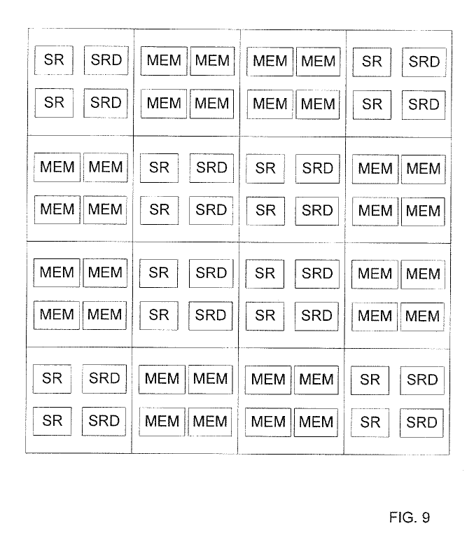

FIG. 9 illustrates an example architecture on which the FSS can be performed, such as the architecture disclosed in U.S. provisional patent application 60/734,623, filed Nov. 7, 2005, and entitled “Tessellated Multi-Element Processor and Hierarchical Communication Network”, as well as the architecture disclosed in U.S. provisional patent application 60/850,078, entitled “Reconfigurable Processor Array and Debug Network”, both assigned to the assignee of this application, and incorporated by reference herein. The SRD processors, which are relatively large and include more calculation capability, could be used for performing the difference calculations, while the SRs, which are relatively smaller, could be used for ordering buffer data. The basic compute resource required for each “FSS-point” is the equivalent of 256 SAD signatures.

Interesting features in phase two include where to start the search for each level and controlling the cost function for each level. Embodiments of the invention use a parent vector for each level to start the search, and cost is controlled by performing several techniques. First, if a region is on an edge, the relative cost of a vector is reduced by a parameterized factor, such as ⅔. Also, when a decision has been made at each level, QP is applied to generate a “true cost” for that level. The vector-cost at all lower-levels is compared to the “true cost” and the search is aborted if the vector cost is greater. This stops smaller partitions being chosen when QP is high.

Thus, phase two is a refinement of phase one. Vector smoothing is helped by using parent vectors for each level, using QP to affect decisions at lower levels, and using the edges of motion regions.

The techniques of phase one and phase two are inherently scalable, and can operate on video frames of almost any size.

Different embodiments of phase two could operate on predicted vectors rather than those determined in phase one. For example, they could be predicted from results of the first loop of phase two. Additional refinements could further smooth the vector field, in addition to predictions, using more than one candidate parent vector per macroblock, using QP during the search, and using topology features from the phase one vector field.

Embodiments implementing phase two may use QP to limit the number of partitions, use a parent hierarchy to find better matches, and may use vector field topology to bias partitioning.

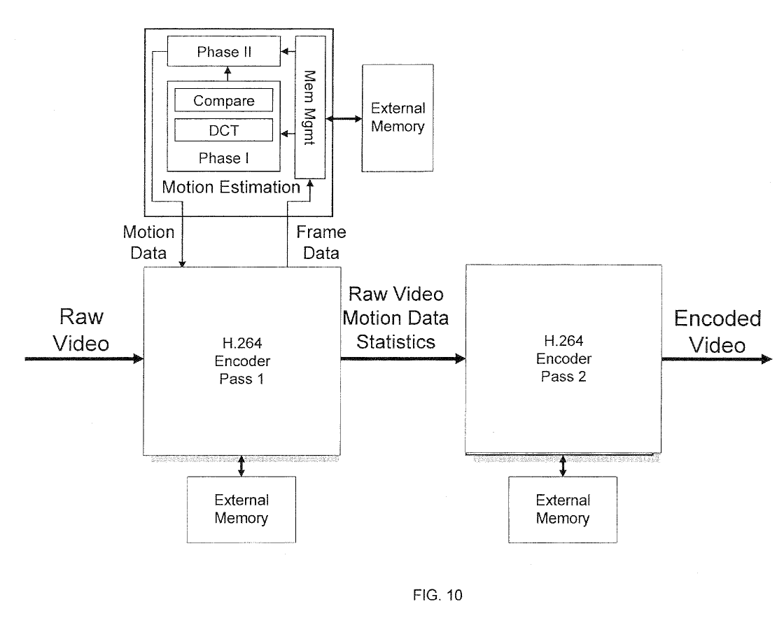

FIG. 10 illustrates how the above-referenced hardware architecture could be implemented in a chipset to implement an H.264 encoder. As described above, uncompressed, raw digital video is presented to a Pass 1 encoder, which sends frame data to a group of processors configured to process the video according to embodiments of the invention. A phase one process exhaustively compares all the motion vectors for each 16×16 macroblock in a video frame and determines a few, choice vectors to send on. Once determined, the second phase refines the search for every partition size and for fractional vectors. Motion data is returned to the Pass 1 encoder, which is passed to a Pass 2 encoder, along with the raw video data. The Pass 2 encoder finalizes the encoding by inserting the motion vectors into the compressed video stream according to a relevant video compression standard, but can now make decisions based on the actual coded number of bits generated by the Pass 1 encoder Further, Pass 2 can search again when the results from Pass 1 are below quality thresholds, either using different frames or in the same frame as Pass 1; in this case each search is constrained by the results from Pass 1 and any motion estimation is no longer a significant burden on memory bandwidth and compute time.

From the foregoing it will be appreciated that, although specific embodiments of the invention have been described herein for purposes of illustration, various modifications may be made without deviating from the spirit and scope of the invention.

What is claimed is:

1. A method for determining motion vectors in a video, comprising:
creating a match signature in the frequency domain for predetermined macroblocks in a pixel domain in multiple frames of the video;
filtering the match signature to reduce a potential number of comparisons in the signature;
comparing the match signature for a particular macroblock to other macroblock match signatures in adjacent and nearby of the multiple frames by differencing the signatures to generate one or more match values for one or more motion vector candidates;
searching the one or more motion vector candidates by comparing their match values and selecting one or more motion vector match values that correlate with vectors of other macroblocks in the same frame; and
selecting a lowest match value that has a motion vector that best correlates in length and direction with motion vectors for the particular macroblock in nearby frames.

2. A method according to claim 1 in which filtering the match signature disregards predetermined frequency components.

3. A method according to claim 1, in which comparing the match signature further comprises performing a summation of absolute differences.

4. A method according to claim 3, in which performing a summation of absolute differences comprises performing a summation on only on a subset of frequency components.

5. A method according to claim 1, in which comparing the match signature further comprises calculating a summation of a square of differences.

6. A method according to claim 5, in which calculating a summation of a square of differences comprises calculating a summation of a square of differences on only a subset of frequency components.

7. A method according to claim 1, further comprising tagging each macroblock in a set of macroblocks having the one or more motion vector candidates for a further refinement.

8. A method according to claim 1, in which creating a match signature in the frequency domain comprises performing a DCT function.

9. A method according to claim 8, in which performing a DCT function for a 16×16 macroblock comprises tiling 16 4×4 DCT transforms.

10. A method according to claim 1, further comprising comparing match signatures for only portions of the particular macroblock to portions of other macroblocks according to a set of fracture parameters from a first search.

11. A method according to claim 10, in which a portion of the particular macroblock is 16×8 pixels in size.

12. A method according to claim 10, in which a portion of the particular macroblock is 8×16 pixels in size.

13. A method according to claim 10, in which a portion of the particular macroblock is 8×8 pixels in size.

14. A method according to claim 10, in which a portion of the particular macroblock is 8×4 pixels in size.

15. A method according to claim 10, in which a portion of the particular macroblock is 4×8 pixels in size.

16. A method according to claim 10, in which a portion of the particular macroblock is 4×4 pixels in size.

17. A method according to claim 10, in which the set of fracture parameters are influence by edge orientation of regions with similar vector regions.

18. A motion estimator for a video stream, comprising:
a match signature generator having a frame data input coupled to a video stream, the generator structured to produce a match signature in the frequency domain for predetermined macroblocks in multiple frames of the video stream;
a filter coupled to the signature generator and structured to reduce a number of signature elements within the match signature;
a comparator coupled to the filter and structured to produce one or more match values for one or more motion vector candidates for a particular macroblock;
a first search element structured to accept the match values and motion vector candidates as inputs and configured to select one or more best motion vector candidates based on vectors of other macroblocks in the same frame as the particular macroblock; and
a second search element structured to accept the one or more best motion vector candidates as an input and configured to select one of the candidates as a best match value.

19. A motion estimator according to claim 18, in which the filter is structured to disregard selected frequency components.

20. A motion estimator according to claim 18, in which the comparator comprises an adder structured to sum absolute differences.

21. A motion estimator according to claim 20, in which the adder is structured to operate on only on a subset of frequency components.

22. A motion estimator according to claim 18, further comprising a selector configured to identify selected macroblocks in a set of macroblocks having the one or more best motion vector candidates for a further refinement.

23. A motion estimator according to claim 18, in which the match signal generator comprises a DCT generator.

24. A motion estimator according to claim 23, in which the DCT generator is configured to tile 16 4×4 DCT transforms into a 16×16DCT transform.

25. A motion estimator according to claim 18, in which the comparator is configured to select match values based on comparisons of only portions of the particular macroblock to portions of other macroblocks according to a set of fracture parameters from a first comparison.

26. A motion estimator according to claim 25, in which a portion of the particular macroblock is 16×8 pixels in size.

27. A motion estimator according to claim 25, in which a portion of the particular macroblock is 8×16 pixels in size.

28. A motion estimator according to claim 25, in which the comparator is structured to consider edge orientation fracture parameters.
